(19) United States
(12) Patent Application Publication
(10) Pub. No.: US 2026/0225118 A1
(43) Pub. Date: Aug. 6, 2026

(54) PAINT CHAMBER UNIT FOR ELECTROSTATIC ATOMIZATION PAINTING MACHINE

(71) Applicant: TAIKISHA LTD., Tokyo (JP)

(72) Inventors: Keiji MANABE, Tokyo (JP); Shogo NODA, Tokyo (JP); Ryuto AKAOGI, Tokyo (JP)

(73) Assignee: TAIKISHA LTD., Tokyo (JP)

(21) Appl. No.: 19/150,957

(22) PCT Filed: Dec. 13, 2023
(86) PCT No.: PCT/JP2023/044606

§ 371 Date: Jul. 25, 2025

(30) Foreign Application Priority Data
Jan. 31, 2023 (JP) 2023-012957

(51) Int. Cl. B05B 5/08; B05B 5/16

(52) U.S. Cl. CPC B05B 5/08; B05B 5/16

(57) ABSTRACT

A paint chamber unit for an electrostatic atomization painting machine includes: nozzles; a paint chamber that extends between an outflow port row in which outflow ports respectively connected to the nozzles are arranged in a row and an inflow port into which paint is to flow; and an on-off valve configured to open and close the inflow port. A width of the paint chamber along the outflow port row of the paint chamber gradually increases from the inflow port toward the outflow port row.

### TECHNICAL FIELD

The present invention relates to a nozzle head for an electrostatic atomization painting machine.

### BACKGROUND ART

Painting robots are widely used to automate the painting of automobile bodies and the like. As one typical mode of painting robots, industrial robots with a paint nozzle attached to the tip of the robot are widely used. Such paint nozzles employ various structures according to the painting method.

For example, JP 2018-008253A (Patent Document 1) discloses an electrostatic spray device used to perform painting of an electrostatic painting method. The electrostatic spray device of Patent Document 1 is provided with a nozzle head in which a plurality of nozzles is arranged in an annular shape.

In this type of nozzle head, when the nozzles are directed laterally to paint, problems may arise due to the water head difference between the nozzles located at upper and lower positions. In the nozzle head described in Patent Document 1, a resistive part is provided in a paint channel to reduce the water head difference between the upper and lower nozzles.

### PRIOR ART DOCUMENT

### Patent Document

Patent Document 1: JP 2018-008253A

### DISCLOSURE OF THE INVENTION

### Problem to be Solved by the Invention

In the third embodiment of the invention described in Patent Document 1, the nozzle head includes a first head part and a second head part, and a space is formed between the tip of the first head part and base ends of nozzles provided in the second head part. This space serves to distribute the paint to the nozzles. However, when such a space is provided, the volume of the paint channel in the nozzle head is relatively large, and thus the amount of paint that is wasted when changing the paint (typically referred to as “color change”) tends to increase.

Therefore, there is a need to realize a nozzle head for an electrostatic atomization painting machine that can suppress the volume of a paint channel in the nozzle head while avoiding a problem caused by the water head difference between nozzles.

### Means for Solving Problem

A nozzle head for an electrostatic atomization painting machine according to the present invention includes: nozzles; a paint chamber that extends between an outflow port row in which outflow ports respectively connected to the nozzles are arranged in a row and an inflow port into which paint is to flow; and an on-off valve configured to switch between allowing and not allowing the paint to flow into the inflow port, a width of the paint chamber along the outflow port row of the paint chamber gradually increasing from the inflow port toward the outflow port row.

With this configuration, the width of the paint chamber on the inflow port side can be suppressed, thus facilitating the suppression of the volume of the paint chamber. Also, the gradual increase in the width of the paint chamber from the inflow port to the outflow port row makes it easier to achieve a uniform velocity of paint flowing toward the respective outflow ports (nozzles), thus avoiding problems caused by the water head difference.

Further features and advantages of the present invention will become more apparent based on the following exemplary and non-limiting embodiments, which are described with reference to the drawings.

### BRIEF DESCRIPTION OF THE DRAWINGS

FIG. 1 is a side view of a nozzle head according to an embodiment.

FIG. 2 is a front view of the nozzle head according to the embodiment.

FIG. 3 is a schematic cross-sectional view of a paint chamber according to the embodiment.

FIG. 4 is a diagram of the paint chamber according to the embodiment, viewed from the leading end of the nozzle head.

FIG. 5 is a schematic cross-sectional view of the paint chamber according to the embodiment.

FIG. 6 shows a nozzle head according to a modification in a side view and a front view.

### DESCRIPTION OF EMBODIMENTS

An embodiment of a nozzle head for an electrostatic atomization painting machine according to the present invention will be described with reference to the drawings. The following description takes an example in which the nozzle head for an electrostatic atomization painting machine according to the present invention is applied to a nozzle head 1 for an electrostatic atomization painting machine that paints a painting target object by spraying paint.

### Configuration of Nozzle Head

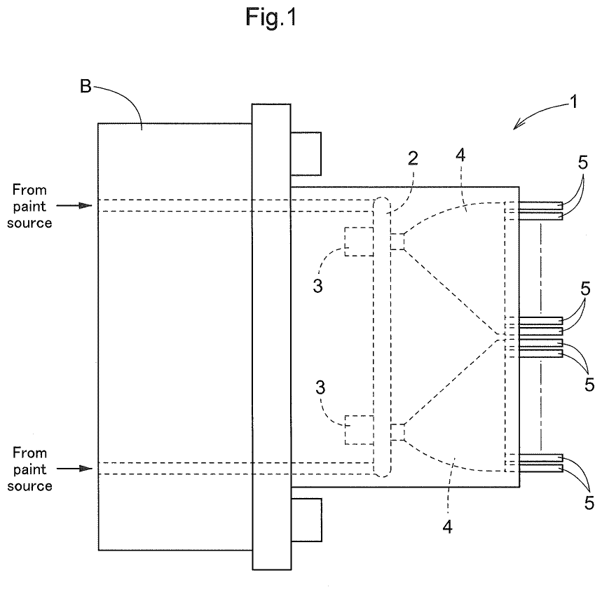

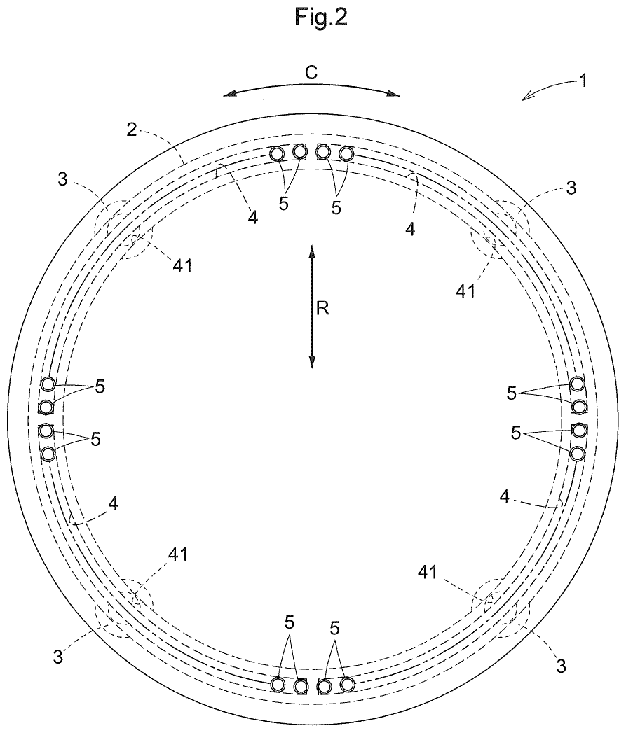

The nozzle head 1 according to the present embodiment, in use, is attached to a body part B of a painting robot (not shown) on a side opposite to the side connected to a work arm of the painting robot (FIGS. 1 and 2).

The nozzle head 1 includes a distribution channel 2, on-off valves 3, paint chambers 4, and nozzles 5. More specifically, one annular distribution channel 2 that is in fluid communication with a paint source (not shown) is provided, and this distribution channel 2 is in communication with four paint chambers 4. The on-off valves 3 are provided so as to be able to open and close communication sections between the distribution channel 2 and the respective paint chambers 4, meaning that four on-off valves 3 are provided. The nozzles 5 are connected to the respective paint chambers 4. Also, the nozzles 5 are arranged in a circular shape at the leading end of the nozzle head 1 (FIG. 2). In other words, in the present embodiment, there are four paint chamber units each including a plurality of nozzles 5, a paint chamber 4, and an on-off valve 3.

The electrostatic atomization painting machine is provided with a voltage application device (not shown) that creates an electric potential difference between a paint target object and the nozzle head 1, and paint ejected from nozzles 5 is charged by a high voltage applied by the voltage application device. The high voltage applied by the voltage application device creates electric fields around the openings of the nozzles 5, and the charged paint ejected from each of the nozzles 5 is atomized by so-called electrostatic spraying, namely, the action of the electric field formed around the opening of the nozzle 5. The atomized and charged paint is then electrostatically attracted to the painting target object by the electric potential difference between the nozzle head 1 and the painting target object, and flies to be applied to the surface of the painting target object.

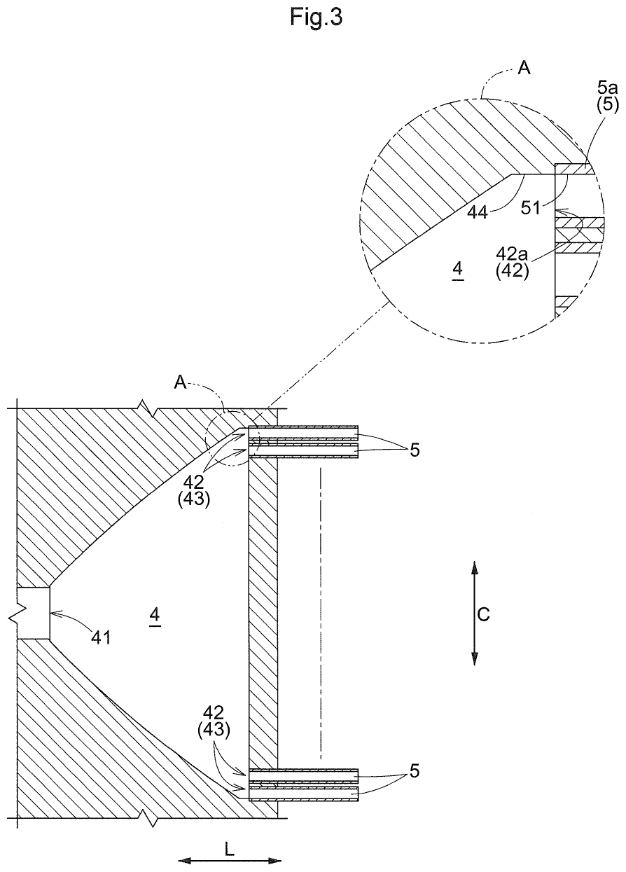

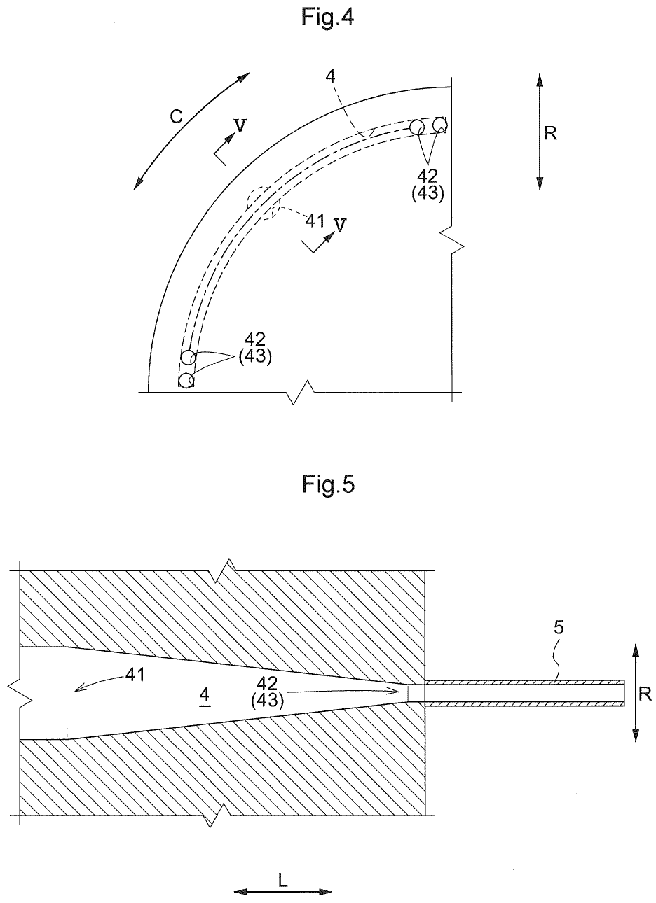

Each paint chamber 4 includes an inflow port 41 into which paint flows and outflow ports 42 respectively connected to the nozzles 5 (FIGS. 3 and 4). The outflow ports 42 form an outflow port row 43 in which they are arranged in a row, and the paint chamber 4 extends from the inflow port 41 to the outflow port row 43. Corresponding to the circular arrangement of the nozzles 5 as described above, the outflow port row 43 is curved (arc-shaped). Accordingly, the paint chamber 4 has a curved shape on a leading end-side of the nozzle head 1. Note that, for convenience, the paint chamber 4 is shown as having a flat surface in FIG. 3.

The width of the paint chamber 4 along the outflow port row 43 (hereinafter simply referred to as “width of the paint chamber 4”) gradually increases from the inflow port 41 toward the outflow port row 43. The width of the paint chamber 4 is the width along the direction (circumferential direction) along the curve of the outflow port row 43, and this direction is indicated by the reference sign C in FIGS. 3 and 4. Specifically, the width of the paint chamber 4 is substantially equal to the inner diameter of the inflow port 41 on a base end-side (close to the distribution channel 2, which is the left-hand side in FIG. 3), and is substantially equal to the length of the outflow port row 43 on a leading end-side (close to the nozzles 5, which is the right-hand side in FIG. 3). In the region between the base end and the leading end, the width of the paint chamber 4 increases substantially linearly from the base end-side to the leading end-side.

Also, the width of the paint chamber 4 along a direction orthogonal to the extending direction of the paint chamber 4 (hereinafter referred to as “thickness of the paint chamber 4”) gradually decreases from the inflow port 41 toward the outflow port row 43 (FIG. 5). The extending direction of the paint chamber 4 is a direction from the base end-side toward the leading end-side, and this direction is indicated by the reference sign L (left-right direction on the paper plane) in FIG. 3. A direction R orthogonal to the direction L is a direction orthogonal to the paper plane of FIG. 3 and is the radial direction of the curve of the outflow port row 43. The thickness of the paint chamber 4 is substantially equal to the inner diameter of the inflow port 41 on the base end-side, and is substantially equal to the inner diameter of the outflow ports 42 on the leading end-side. In the region between the base end and the leading end, the thickness of the paint chamber 4 decreases substantially linearly from the base end-side to the leading end-side.

A view A in FIG. 3 is an enlarged view of an end of the outflow port row 43. At the end of the outflow port row 43, an inner surface 44 of the paint chamber 4 extending along the extending direction (direction L) of the paint chamber 4 is flush with an inner surface 51 of a nozzle 5a connected to an outflow port 42a located at the end of the outflow port row 43. This can suppress the resistance of the paint when it flows into the nozzle 5a at the end, thus facilitating a uniform flow of the paint into the nozzle 5a.

The distribution channel 2 is an annular pipe that is in fluid communication with the paint source via the body part B. The distribution channel 2 is communicated with the inflow ports 41 of the paint chambers 4 at four positions and serves to distribute the paint supplied from the paint source to the four paint chamber units. The inner diameter of the distribution channel 2 is preferably selected so that the velocity of the paint in the distribution channel 2 is lower than the velocities of the paint in the paint chambers 4 and the nozzles 5. Note that, in the present embodiment, the distribution channel 2 is communicated with each of the inflow ports 41 via a short pipe. Each on-off valve 3 is provided in the communication section between the distribution channel 2 and the corresponding inflow port 41, and opens and closes the communication section to switch between allowing and not allowing the paint to flow into the inflow port 41. The on-off valves 3 can be powered by a suitable power source such as electricity, pneumatic pressure, or hydraulic pressure.

In the present embodiment, 100 nozzles 5 are provided at equal intervals. Therefore, 25 nozzles 5 are connected to one paint chamber 4. Adjacent nozzles 5 are spaced at an interval of 3 mm. Note that these numeric values are only examples to aid understanding of the present embodiment and do not limit the present invention.

In the present embodiment, each nozzle 5 is implemented as a straight pipe with an outer diameter of 0.8 mm, an inner diameter of 0.3 mm, a wall thickness of 0.25 mm, and a length of 60 mm. The dimensions of the nozzles 5 are selected as appropriate according to the properties (such as the type of solvent, viscosity, and solid concentration) of the paint for use, the size of a paint target object, and the like. In particular, it is preferable that the dimensions be set in view of, for example, suppressing variations in the discharge rate between the nozzles 5 and preventing paint dripping from the leading ends of the nozzles 5 by using capillary action. For example, the inner diameter of the nozzles 5 is preferably 0.2 mm or more and 1.0 mm or less because this can easily realize a uniform discharge rate for the nozzles 5. Also, the length of the nozzles 5 is preferably 5 mm or more and 100 mm.

The inner diameter of the nozzles 5 at the leading ends thereof is preferably 0.2 mm or more and 0.7 mm or less because this easily avoid problems (such as liquid dripping and air inflow) caused by the water head difference between the nozzles. Here, as can be seen from the specification of the preferable dimensions for the inner diameter at the leading end, the nozzle 5 may have a uniform inner diameter over its entire length, or the inner diameter may vary in part.

In addition, when the nozzle head 1 is positioned so that the nozzles 5 extend in the horizontal direction, a water head difference, which is the difference between the water head pressure at the nozzle 5 located at the highest position and the water head pressure at the nozzle 5 located at the lowest position, is preferably within 10% of the water head pressure at the nozzle 5 located at the lowest position.

Note that the dimensions of the nozzles 5 and the dimensions of the paint chamber 4 can be determined in conjunction with each other. Directly, an outflow port 42 of the paint chamber 4 is connected to a nozzle 5, so the inner diameter of the outflow port 42 can match the inner diameter of the nozzle 5. In the present embodiment, the inner diameter of the outflow port 42 is 0.3 mm. Also, the inner diameter of the inflow port 41 is determined at a level that can realize a supply capacity of allowing uniform supply of paint to all the nozzles 5. In the present embodiment, the inner diameter of the inflow port 41 is 3 mm. Therefore, in the present embodiment, the cross-sectional area of the flow channel in the nozzle 5 is smaller than the cross-sectional area of the inflow port 41.

### Functional Effects of Nozzle Head

In the nozzle head 1 according to the present embodiment, the width of the paint chamber 4 gradually increases from the inflow port 41 toward the outflow port row 43, so that the velocities of paint flowing toward the outflow ports 42 (nozzles 5) tends to be uniform. In addition, as the nozzle head 1 has a structure that prevents the formation of steps around the inflow port 41 and around each outflow port 42, paint is less likely to accumulate. In addition, there is no need to provide an on-off valve inside the paint chamber 4 to open and close each nozzle, and thus the volume of the paint chamber 4 can be reduced compared to conventional nozzle heads of the same type. With this, it is possible to reduce the amount of paint that is wasted during color change. In addition, due to the absence of any on-off valve inside the paint chamber, the inner structure of the paint chamber is simpler than the conventional structure, so it is easier to clean the nozzle head at the time of color change compared to in conventional cases. The fact that the width of the paint chamber on the inflow port 41 side can be suppressed also contributes to the suppression of the volume of the paint chamber 4.

### Modification

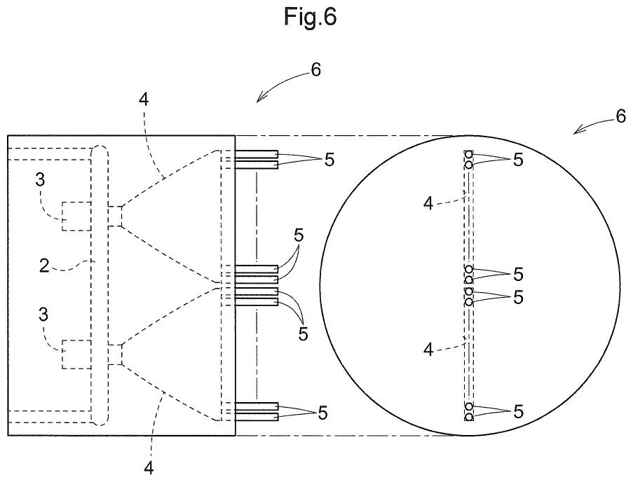

In a nozzle head 6 shown in FIG. 6, nozzles 5 are arranged linearly at the leading end of the nozzle head 6. Also in this case, paint chambers 4 having the same configuration as in the above-described embodiment can be provided. Note that, in the present invention, the arrangement of the nozzles is not limited to those in the above-described embodiment (FIGS. 1 to 5) and the modification (FIG. 6).

### Other Embodiments

Lastly, other embodiments of the nozzle head for an electrostatic atomization painting machine according to the present invention are described. Note that the configurations disclosed in the following embodiments can be applied in combination with the configurations disclosed in other embodiments as long as no contradiction arises.

The embodiment above has described, as an example, a configuration in which the on-off valve 3 is located in the communication section between the inflow port 41 and the distribution channel 2. However, the location of the on-off valve of the present invention is not limited as long as it can switch between allowing and not allowing paint to flow into the inflow port.

The embodiment above has described, as an example, a configuration in which the nozzle head 1 includes the multiple paint chambers 4. However, in the present invention, the number of paint chambers may be one or more.

The embodiment above has described, as an example, a configuration in which the cross-sectional area of the flow channel in the nozzle 5 is smaller than the cross-sectional area of the inflow port 41. However, in the present invention, the magnitude relationship between the cross-sectional area of the flow channel in the nozzle and the cross-sectional area of the inflow port is not limited.

With regard to other configurations, it should be understood that the embodiments disclosed in the present specification are in all respects illustrative and the scope of the present invention is not limited thereto. Those skilled in the art will readily understand that modifications can be made to the extent without departing from the gist of the present invention. Therefore, other embodiments modified without departing from the gist of the present invention are naturally included in the scope of the present invention.

### DESCRIPTION OF REFERENCE SIGNS

1: Nozzle head
2: Distribution channel
3: On-off valve
4: Paint chamber
41: Inflow port
42: Outflow port
43: Outflow port row
44: Inner surface
5: Nozzle
51: Inner surface
6: Nozzle head (modification)

1.-7. (canceled)

8. A paint chamber unit for an electrostatic atomization painting machine comprising:
nozzles;
a paint chamber that extends between an outflow port row in which outflow ports respectively connected to the nozzles are arranged in a row and an inflow port into which paint flows; and
an on-off valve configured to switch between allowing and not allowing the paint to flow into the inflow port,
a width of the paint chamber along the outflow port row gradually increasing from the inflow port toward the outflow port row.

9. The paint chamber unit for the electrostatic atomization painting machine according to claim 8,
wherein a width of the paint chamber along a direction orthogonal to an extending direction of the paint chamber gradually decreases from the inflow port toward the outflow port row.

10. The paint chamber unit for the electrostatic atomization painting machine according to claim 8,
wherein an inner surface of the paint chamber extending along an extending direction of the paint chamber is flush with an inner surface of a nozzle connected to an outflow port located at an end of the outflow port row.

11. The paint chamber unit for the electrostatic atomization painting machine according to claim 8,
wherein each of the nozzles has a leading end having an inner diameter of 0.2 mm or more and 0.7 mm or less.

12. The paint chamber unit for the electrostatic atomization painting machine according to claim 8,
wherein the nozzles have an inner diameter of 0.2 mm or more and 1.0 mm or less.

13. The paint chamber unit for the electrostatic atomization painting machine according to claim 8,
wherein the nozzles have a length of 5 mm or more and 100 mm or less.

14. A nozzle head for an electrostatic atomization painting machine, the nozzle head comprising:
the paint chamber unit according to claim 8.

15. The nozzle head for the electrostatic atomization painting machine according to claim 14,
wherein the paint chamber unit is a plurality of paint chamber units.

16. The nozzle head for the electrostatic atomization painting machine according to claim 14, further comprising:
a distribution channel configured to distribute paint supplied from a paint source to the paint chamber units, wherein
the inflow port of each paint chamber unit is in communication with the distribution channel, and the on-off valve of each paint chamber unit opens and closes a communication section between the distribution channel and the inflow port of the corresponding paint chamber unit.

17. The nozzle head for the electrostatic atomization painting machine according to claim 14,
wherein a width of the paint chamber along a direction orthogonal to an extending direction of the paint chamber gradually decreases from the inflow port toward the outflow port row.

18. The nozzle head for the electrostatic atomization painting machine according to claim 14,
wherein an inner surface of the paint chamber extending along an extending direction of the paint chamber is flush with an inner surface of a nozzle connected to an outflow port located at an end of the outflow port row.

19. The nozzle head for the electrostatic atomization painting machine according to claim 14,
wherein each of the nozzles has a leading end having an inner diameter of 0.2 mm or more and 0.7 mm or less.

20. The nozzle head for the electrostatic atomization painting machine according to claim 14,
wherein the nozzles have an inner diameter of 0.2 mm or more and 1.0 mm or less.

21. The nozzle head for the electrostatic atomization painting machine according to claim 14,
wherein the nozzles have a length of 5 mm or more and 100 mm or less.

22. The nozzle head for the electrostatic atomization painting machine according to claim 16,
wherein a width of the paint chamber along a direction orthogonal to an extending direction of the paint chamber gradually decreases from the inflow port toward the outflow port row.

23. The nozzle head for the electrostatic atomization painting machine according to claim 16,
wherein an inner surface of the paint chamber extending along an extending direction of the paint chamber is flush with an inner surface of a nozzle connected to an outflow port located at an end of the outflow port row.

24. The nozzle head for the electrostatic atomization painting machine according to claim 16,
wherein each of the nozzles has a leading end having an inner diameter of 0.2 mm or more and 0.7 mm or less.

25. The nozzle head for the electrostatic atomization painting machine according to claim 16,
wherein the nozzles have an inner diameter of 0.2 mm or more and 1.0 mm or less.

26. The nozzle head for the electrostatic atomization painting machine according to claim 16,
wherein the nozzles have a length of 5 mm or more and 100 mm or less.
